(19) United States
(12) Patent Application Publication
(10) Pub. No.: US 2006/0047784 A1
(43) Pub. Date: Mar. 2, 2006

(54) Method, apparatus and system for remotely and dynamically configuring network elements in a network

(76) Inventors: Shuping Li, Beaverton, OR (US); Jeyaram Krishnasamy, Beaverton, OR (US)

Correspondence Address: INTEL CORPORATION, P.O. BOX 5326, SANTA CLARA, CA, 95056-5326, US

(21) Appl. No.: 10/932,513

(22) Filed: Sep. 1, 2004

(51) Int. Cl. G06F 15/177

(52) U.S. Cl. 709/220

(57) ABSTRACT

A method, apparatus and system enable remote, responsive and dynamic management and configuration of various network elements on wired or wireless networks. In one embodiment, a host controller may obtain privileges to remotely configure network elements that include a configuration module. The host controller may additionally communicate with network elements on different networks via secure tunnels between the networks.

### BACKGROUND

Networks today are becoming increasingly complicated as they become larger and a variety of new network elements are introduced into the topology. A network element typically includes various network devices as well as the sub-networks within a network. The concept of sub-networks is well known to those of ordinary skill in the art. By way of example, FIG. 1 illustrates a typical configuration wherein a corporate network (Private Network 100) is coupled to a public network (Public Network 150). Private Network 100 may be considered a sub-network of Public Network 150. As illustrated, these networks are likely to include a large number of network components such as routers, firewalls and gateways (a subset of such devices illustrated as Devices 105, 110, 115, 120, 125, 130, 135, Gateway 175 and Gateway 185). In the illustrated example, Private Network 100 may also be coupled to another sub-network (“Sub Network 190”) via Gateway 185. As a result of this increasing complexity, network management has become an intricate and sometimes monumental task. Amazingly, many of these tasks are currently performed manually, e.g., in order to add a router to a network, a network administrator may have to manually configure various components on the network to recognize the addition of the new router. As the size and complexity of networks increases, this manual approach presents significant difficulties and drawbacks.

### BRIEF DESCRIPTION OF THE DRAWINGS

The present invention is illustrated by way of example and not limitation in the figures of the accompanying drawings in which like references indicate similar elements, and in which:

FIG. 1 illustrates a typical corporate network environment coupled to a public network;

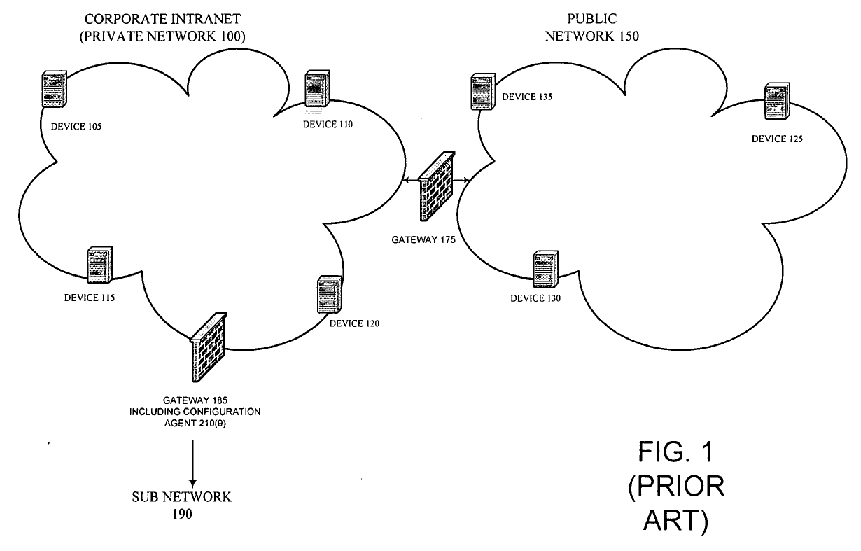

FIG. 2 illustrates an embodiment of the present invention within the environment of FIG. 1;

FIG. 3 illustrates how an embodiment of the present invention may be utilized to enable secure communications between elements on a public network and a private network; and

FIG. 4 is a flowchart illustrating an embodiment of the present invention;

### DETAILED DESCRIPTION

Embodiments of the present invention provide a method, apparatus and system for remotely, responsively and dynamically configuring network elements on a network. Any reference in the specification to “one embodiment” or “an embodiment” of the present invention means that a particular feature, structure or characteristic described in connection with the embodiment is included in at least one embodiment of the present invention. Thus, the appearances of the phrases “in one embodiment,” “according to one embodiment” or the like appearing in various places throughout the specification are not necessarily all referring to the same embodiment.

As previously described, network administration is becoming an increasingly complex task as networks expand and the types of devices on the networks multiply. Although it may be possible currently for a network administrator to remotely manage a group of specific devices (e.g., all routers on a particular network), there is no methodology available by which a network administrator may view or configure different types of network devices (e.g., routers, firewalls, servers, gateways, etc), sub-networks, and/or manage a network topology across networks (e.g., across Public Network 150, Private Network 100 and/or Sub Network 190) from a single host. Embodiments of the present invention enable remote, dynamic, automatic and responsive configuration of various network devices and management of the network topology on wired and/or wireless networks, regardless of where the network devices reside. Thus, for example, according to an embodiment of the present invention, a network administrator may utilize one host devices on a network to remotely configure a network and/or various devices on the network. The network may comprise a public network and/or a private network (i.e., one wherein the network devices reside behind a security mechanism, e.g., a firewall). In one embodiment, if a new device network device is introduced or removed from the network topology, then the network device configuration may be changed. According to embodiments of the present invention, the host may remotely and dynamically configure all network elements, i.e., both the devices coupled to the network as well as the active sub-networks on the network. In other words, in one embodiment, when a host remotely invokes the network devices (as described in further detail below) to complete certain configuration tasks, depending on the configuration tasks, the devices may logically connect or disconnect from the network. By extension, entire sub-networks may be logically connected or disconnected from the network (e.g., all packets to and from a particular sub-network may be added or dropped from the network, thus effectively connecting or disconnecting the sub-network from the rest of the network). Embodiments of the present invention thus provide network administrators with significant control over network device and topology management from a single host device on the network.

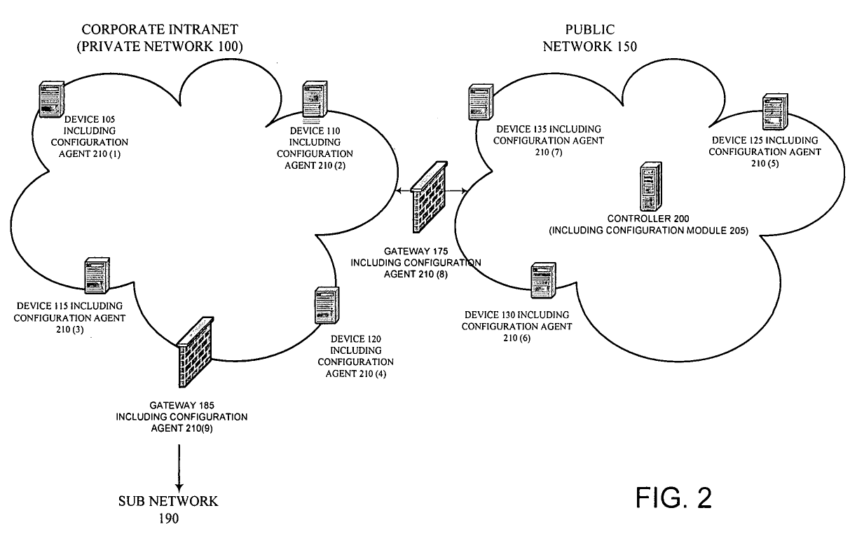

FIG. 2 illustrates an embodiment of the present invention. According to this embodiment, the network(s) may include at least one “controller device” (illustrated collectively as “Controller 200”) with configuration modules (“Configuration Module 205”) comprising software, hardware, firmware and/or any combination thereof. Although Controller 200 is illustrated in this embodiment as residing on Public Network 150, embodiments of the present invention are not so limited. Instead, Controller 200 may reside on any network (i.e., Public Network 150, Private Network 100 or Sub Network 190), depending on the configuration scope and need. For the purposes of this specification, the network on which Controller 200 resides may be referred to as a “local network” while other networks (i.e., ones on which Controller 200 does not reside) may be referred to as “remote networks.”

Additionally, the following description assumes the use of a single control point, i.e., a single Controller 200, but embodiments of the present invention are not so limited. In various other embodiments, more than a single controller may be utilized on the networks. Each element on the network may in turn include a “configuration agent” (“Configuration Agents 210(1)-(7), collectively Configuration Agents). Configuration Module 205 on Controller 200 may enable communication between the various network elements that include Configuration Agents (the network elements including Configuration Agents hereafter referred to collectively as “Configured Network Elements”).

Thus, for example, as illustrated, Controller 200 may comprise a host device coupled to a local network (which in this example comprises Public Network 150) and Configuration Module 205 may transmit topology information to Configuration Agent 210(8) on Gateway 175 to configure Controller 205 to include privileges to communicate with any of the Configured Network Elements on any of the networks, i.e., Public Network 150 and/or Private Network 100. These privileges may be established based on the input topology information, and may not be changed until the input topology information is changed. The privileges enable Controller 205 to remotely affect the topology of the network (i.e., the actual devices active and/or participating on the network) as well as the configurations on the Configured Network Elements for desired validation and/or trouble shooting. As used herein, the terms “configure” and/or “configuration” shall include both network topology management as well as configuration of the Configured Network Element.

In one embodiment, Configuration Module 205 may establish a connection and communicate with the Configuration Agents on the various Configured Network Elements via any type of existing and/or future network connection. Configuration Module 205 may include the capability of presenting an interface to an administrator to select various Configured Network Elements (regardless of type) and to input information (e.g., network topology and/or device configuration information). Configuration Module 205 may additionally include the capability of transmitting the information to the appropriate Configured Network Element, regardless of where the Configured Network Element resides. Thus, for example, if Controller 200 and Configuration Module 205 reside on Public Network 150 (the local network) and the selected Configured Network Element resides on Private Network 100 (the remote network), Configuration Module 205 may include the capability of establishing a secure connection (e.g., via Gateway 175, including Configuration Agent 210(8)) between Controller 200 and the selected Configured Network Element prior to transmitting the configuration information to the selected Configured Network Element. The capability of establishing secure connections is described in further detail below.

As previously described, network administrators may currently remotely manage specific types of network devices across networks, e.g., routers. There is, however, currently no means by which the network administrator may manage various types of devices and/or traverse firewalls or other such security measures that separate various networks. In other words, although a network administrator on a private network may remotely manage a set of specific devices within the network, the administrator may not administer similar devices residing on a separate network (private or public). Embodiments of the present invention, however, may be used not only with various devices but also between network, e.g., between a public (non-secured) network and private (secured) networks. More specifically, according to an embodiment of the present invention, Controller 205 may create a “tunnel” (illustrated as “Secure Tunnel 300”) between the public and private networks, and thereafter enable communications between the devices on both networks via the tunnel. The concept of tunnels is well known to those of ordinary skill in the art and further description thereof is omitted herein in order not to unnecessarily obscure embodiments of the present invention. It will be readily apparent to those of ordinary skill in the art that various types of tunnels (e.g., tailored for the communications protocols being used) may be utilized without departing from the spirit of embodiments of the present invention.

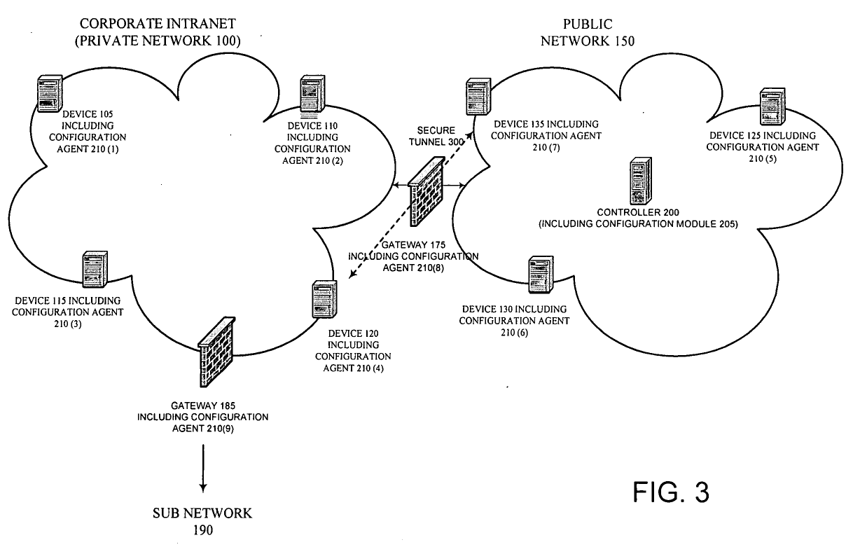

Thus, for example, embodiments of the present invention may be utilized to automatically validate the secured communications between a non-secured (e.g., Public Network 150) and a secured network (e.g., Private Network 100). In this example, as illustrated in further detail in FIG. 3, the network interface card (“NIC”) drivers on the various Configured Network Devices on Private Network 100 and Public Network 150 may be tested for security. In one embodiment, the user may provide Controller 205 (or Controller 205 may automatically obtain) configuration information for Configured Network Devices on Private Network 100. Since Private Network 100 is a remote network, i.e., one separated from local network (Public Network 150) by a gateway, Controller 205 may send messages to Gateway 175 to establish communications policies, such that Controller 205 has privileges to access all the Configured Network Elements on Private Network 100 (including any other gateways that may be configured on Private Network 100, e.g., Gateway 185 with Configuration Agent 210(9)). Controller 205 may then directly invoke the secure NIC driver to configure applications Configured Network Devices on Private Network 100, Public Network 150 and Gateway 175's Configuration Agent 210(8) in order to establish secured tunnels between Private Network 100 and Public Network 150 through Gateway 175. Controller 205 may then remotely configure the Configured Network Devices on Private Network 100 to enable their secured communication with the public network. If Private Network 100 includes another gateway (e.g., Gateway 185 comprising Configuration Agent 210(9), then Controller 205 may then send messages to Gateway 185 to establish communications policies such that Controller 205 has privileges to access all Configured Network Elements on Sub Network 190, and/or enable or disable communication with Sub Network 190.

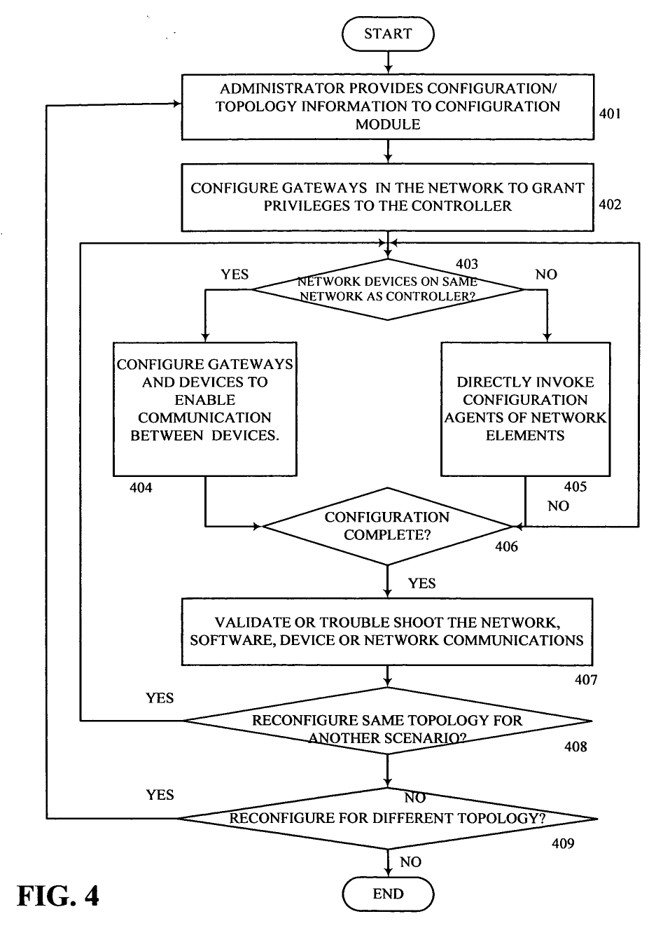

FIG. 4 is a flow chart illustrating an embodiment of the present invention. Although the following operations may be described as a sequential process, many of the operations may in fact be performed in parallel and/or concurrently. In addition, the order of the operations may be re-arranged without departing from the spirit of embodiments of the invention. In 401, an administrator may provide configuration/topology information to a configuration module on a controller. Once the controller has gathered the configuration/topology information, it may invoke the configure agent on the gateways to grant itself privileges to access the entire network in 402. The configuration module may then examine the information to determine whether the network device(s) is on the same network as the controller (i.e., whether the device is on a local or remote network) in 403. If the device resides on remote network, then the configuration module may configure the gateways and devices to establish a secure tunnel between the appropriate devices in 404. If the device is on a local network, i.e., the same network as the controller, then the controller may directly configure the devices in 405.

If the configuration is not complete in 406, the process of 403-406 may repeat itself. If, however, the configuration is complete in 406, then in 407, the administrator may validate or trouble shoot the network, software, device and/or network communications. In 408, if the administrator desires to reconfigure the same network topology for a different scenario (e.g., reconfigure certain configured network devices on the network to set different filters), the process of 403-408 may repeat itself. If, however, the administrator does not wish to reconfigure the same topology but rather desires to reconfigure a different topology in 409, then the process of 401-409 may repeat itself.

The controller and other network devices according to embodiments of the present invention may be implemented on a variety of computing devices. According to an embodiment of the present invention, computing devices may include various components capable of executing instructions to accomplish an embodiment of the present invention. For example, the computing devices may include and/or be coupled to at least one machine-accessible medium. As used in this specification, a “machine” includes, but is not limited to, any computing device with one or more processors. As used in this specification, a machine-accessible medium includes any mechanism that stores and/or transmits information in any form accessible by a computing device, the machine-accessible medium including but not limited to, recordable/non-recordable media (such as read-only memory (ROM), random-access memory (RAM), magnetic disk storage media, optical storage media and flash memory devices), as well as electrical, optical, acoustical or other form of propagated signals (such as carrier waves, infrared signals and digital signals).

According to an embodiment, a computing device may include various other well-known components such as one or more processors. The processor(s) and machine-accessible media may be communicatively coupled using a bridge/memory controller, and the processor may be capable of executing instructions stored in the machine-accessible media. The bridge/memory controller may be coupled to a graphics controller, and the graphics controller may control the output of display data on a display device. The bridge/memory controller may be coupled to one or more buses. One or more of these elements may be integrated together with the processor on a single package or using multiple packages or dies. A host bus controller such as a Universal Serial Bus (“USB”) host controller may be coupled to the bus(es) and a plurality of devices may be coupled to the USB. For example, user input devices such as a keyboard and mouse may be included in the computing device for providing input data. In alternate embodiments, the host bus controller may be compatible with various other interconnect standards including PCI, PCI Express, FireWire and other such current and future standards.

In the foregoing specification, the invention has been described with reference to specific exemplary embodiments thereof. It will, however, be appreciated that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A system comprising:
a controller including a configuration module, the configuration module capable of receiving as input configuration information;
at least two different network devices, each of the at least two different network devices including a configuration agent communicatively coupled to the configuration module, the configuration module capable of transmitting the configuration information from the controller to the configuration agent.

2. The system according to claim 1 wherein the controller and the at least two different network devices reside on a local network.

3. The system according to claim 1 wherein the controller resides on a local network and the at least two different network devices reside on a remote network.

4. The system according to claim 3 wherein the configuration module is further capable of transmitting the configuration information from the controller to the configuration agent after a secure connection is established between the local network and the remote network.

5. The system according to claim 4 wherein the secure connection is established between the local network and the remote network via a gateway.

6. The system according to claim 4 wherein the secure connection comprises a tunnel between the local network and the remote network via the gateway.

7. The system according to claim 6 wherein the configuration module is further capable of transmitting the configuration information from the controller to the configuration agent via the tunnel.

8. The system according to claim 7 wherein the configuration the configuration information is capable of configuring one or more of the at least two different network devices.

9. The system according to claim 1 wherein the configuration information includes network topology information.

10. The system according to claim 1 wherein the configuration information includes configuration information for the at least two different network devices.

11. A method comprising:
receiving configuration information;
determining based on the configuration information whether the configuration information is destined for devices residing one of a local network and a remote network, the remote network separated from the local network by a gateway;
establishing a secure tunnel if the configuration information is destined for the remote network.

12. The method according to claim 11 further comprising transmitting the configuration information directly to the devices if the configuration information is destined for the local network.

13. The method according to claim 11 further comprising:
receiving authorization from a gateway to communicate via the secure tunnel with devices on the remote network; and
transmitting the configuration information to the devices.

14. The method according to claim 11 wherein the configuration information includes topology information for the one of the public network and the private network.

15. The method according to claim 11 wherein the devices on the one of the local network and the remote network include a configuration agent capable of receiving the configuration information.

16. An article comprising a machine-accessible medium having stored thereon instructions that, when executed by a machine, cause the machine to:
receive configuration information;
determine based on the configuration information whether the configuration information is destined for devices residing one of a local network and a remote network, the remote network separated from the local network by a gateway;
establish a secure tunnel if the configuration information is destined for the remote network.

17. The article according to claim 16 wherein the instructions, when executed by the machine, further cause the machine to transmit the configuration information directly to the devices if the configuration information is destined for the local network.

18. The article according to claim 16 wherein the instructions, when executed by the machine, further cause the machine to:
receive authorization from a gateway to communicate via the secure tunnel with the devices on the remote network; and
transmit the configuration information to the devices.

19. The article according to claim 16 wherein the configuration information includes topology information for the one of the public network and the private network.

20. The article according to claim 16 wherein the devices on the one of the public network and the private network include a configuration agent capable of receiving the configuration information.

21. An apparatus comprising:
a computing device including a processor;
an input device coupled to the computing device, the input device capable of accepting configuration information for the computing device; and
a controller coupled to the processor, the controller capable of receiving the configuration information accepted by the input device, the controller further capable of transmitting the configuration information from the controller to a configuration agent residing on a remote device.

22. The apparatus according to claim 21 wherein the controller is further capable of:
determining based on the configuration information whether the configuration information is destined for devices on one of a local network and a remote network, the remote network separated from the local network by a gateway; and
establishing a secure tunnel if the configuration information is destined for the remote network.

23. The apparatus according to claim 22 wherein the controller is further capable of transmitting the configuration information directly to the devices if the configuration information is destined for the local network.

24. The apparatus according to claim 21 wherein the configuration information includes topology information for the one of the local network and the remote network.
